(19) United States
(12) Patent Application Publication
(10) Pub. No.: US 2020/0167745 A1
(43) Pub. Date: May 28, 2020

(54) DATA MANAGEMENT SYSTEM AND METHOD OF DISTRIBUTING A DIGITAL CONTENT FILE

(71) Applicant: MARKANY INC., Seoul (KR)

(72) Inventors: Dong-hwan Shin, Seoul (KR); Kyung-jun Park, Seoul (KR); Hong-joon Ha, Seoul (KR); Lae-wook Lee, Gimpo-si (KR); Hwa-min Yu, Seoul (KR); Jong-uk Choi, Seoul (KR)

(73) Assignee: MARKANY INC., Seoul (KR)

(21) Appl. No.: 16/227,293

(22) Filed: Dec. 20, 2018

(30) Foreign Application Priority Data
Nov. 26, 2018 (KR) 10-2018-0147238

(51) Int. Cl. G06Q 20/12; H04L 29/08; G06F 16/22; G06F 16/11; G06Q 30/06

(52) U.S. Cl. CPC G06Q 20/1235; H04L 67/06; G06Q 30/0601; G06F 16/122; G06F 16/2291

(57) ABSTRACT

Disclosed are a data management system and method of distributing a digital content file by using an on-off hybrid blockchain network technology, in which transaction information data having a large volume is processed on an off-blockchain network and the final results of each transaction are recorded on an on-blockchain network. The system and method have an advantage of increasing the number of transactions that can be processed per second, thereby enabling distribution of a large volume of data. In addition, the system and method can encourage every node across a network to participate in distribution of data as file senders by rewarding each of the nodes for the participation on the basis of the contribution of each node.

### STATEMENT REGARDING GOVERNMENT SPONSORED RESEARCH

This work was supported by the ICT R&D program of MSIT/IITP. [2018-0-00365, Development of on-off hybrid blockchain technology for real-time large-scale data distribution]

### CROSS REFERENCE TO RELATED APPLICATION

The present application claims priority to Korean Patent Application No. 10-2018-0147238, filed Nov. 26, 2018, the entire contents of which is incorporated herein for all purposes by this reference.

### BACKGROUND OF THE DISCLOSURE

### 1. Field of the Disclosure

The present invention relates to a data management system and method of distributing a large volume of digital content files, and a computer-readable recording medium storing a program for executing the method.

### 2. Description of the Background Art

Blockchain technology which recently has emerged refers to a technology in which all nodes connected through a network share the same ledger. When a hacker tries to modulate transactional information recorded in the ledger, the hacker needs to modulate all the distributed pieces of the transactional information recorded in the ledger. Therefore, it is difficult to modulate the ledger when the transactional information is managed by using the blockchain technology. Thus, data recorded in a chain of blocks is reliable.

By recording a history of transactions of a digital content in this reliable chain ledger, it is possible to construct an ecosystem in which all the parties involved in distribution of digital contents can trust each other and share the profits.

Therefore, it is effective for ensuring that digital contents producers earn proper profits.

However, there are problems with distributing a large volume of data by using an existing blockchain technology. For example, the number of transactions that can be processed per second is limited and the maximum size of data that can be transmitted at a time is also limited.

### Document of Related Art

Patent Document

(Patent Literature 1) Korean Patent No. 10-1344828 (Dec. 26, 2013)

### BACKGROUND OF THE DISCLOSURE

The present invention has been made to solve the above-mentioned problems, and an objective of the present invention is to provide a damage management system and method of distributing a digital content file, by using on an on-off hybrid blockchain network technology in which a large volume of data of transactional information is processed on an off-blockchain network and final transmission transaction history information data is recorded on an on-blockchain network at a time. With the system and method, it is possible to increase the number of transactions that can be processed per second. Thus, a large volume of data can be easily distributed. In addition, the system and method provide a data distribution structure in which every node can participate in distribution of data as file senders and the file senders are adequately rewarded on the basis of their contribution.

In order to accomplish the objectives of the present invention, one aspect of the present invention provides a data management system for distributing a digital contents file, the data management system including: at least one file producer node configured to generate at least one digital content file and to transmit a file registration request message containing file producer information data of each producer node and file-related information data of each digital content file which are required for registration of each digital content file, along with file storage contract information data based on a file storage contract with a predetermined file producer node in order to store each of the digital content files and file sale contract information data based on a file sales contract with a predetermined seller node in order to sell each of the digital content files; at least one file provider node configured to collect the digital content files generated by each of the file producer nodes, to store the digital content files in a database (DB) form in a storage unit by grouping the digital content files by file producer node or by digital content file, and to transmit file provision contract information based on a file provision contract with a predetermined file seller node in order to provide each of the file content files; at least one seller node provided with a transmission channel for transmitting each of the digital content files stored in the storage units provided in the respective file provider nodes, and configured to provide a file sale service of selling the digital content files through the transmission channels and to transmit file use contract information data based on a file use contract; at least one file buyer node configured to purchase a specific digital content file in accordance with the file use contract information, on the basis of the file sale service provided by each of the file seller nodes, to download the specific digital content file from the file provider node according to the file provision contract between the file seller node and the file provider node; and at least one file manager node connected with each of the file producer nodes, each of the file provider nodes, each of the file seller nodes, and each of the file buyer nodes via a communication network, the at least one file manager node providing a file distribution service of receiving a file registration request message including file producer information data of each file producer and file-related information data of each digital content file transmitted from each of the file producer nodes, each of the file provider nodes, and each of the file seller nodes, along with file storage contract information data, file sale contract information data, file provision contract information data, and file use contract information data, of storing and managing the received file registration request messages and the received information data in a database form for each digital content file or each file producer node, of receiving file purchase and use information data for a specific digital content file from each of the file buyer nodes, of processing payment for the specific digital content file on the basis of the received file purchase and use information data, and of settling profits of each node involved in the service according to the file storage contract information data, the file sale contract information data, the file provision contract information data, and the file use contract information data.

Preferably, each of the file manager nodes may provide a service of receiving the file registration request message including the file producer information data of each producer node and the file-related information of each of the digital content files transmitted from each of the file producer nodes, along with the file storage contract information data and the file sale contract information data and encrypting the file producer information data of each of the digital content files, the file-related information data of each of the digital content files, the file storage contract information data, and the file sale contract information data, and recording and registering the encrypted information data in a first distributed blockchain ledger.

Preferably, each of the file manager nodes may enable the first distributed blockchain ledger in which the encrypted information data is recorded to be shared by a plurality of file manager nodes connected to a blockchain network.

Preferably, the blockchain network may be configured such that the first distributed blockchain ledger is stored in a distributed manner as a chain of blocks in storage units of the respective file manager nodes, wherein in the first distributed block chain ledger, the encrypted information data including the file producer information data of each digital content file, the file-related information data of each digital content file, the file storage contract information data, and the file sale contract information is recorded and registered.

Preferably, each of the file producer nodes may transmit a file discard request message for each digital content file, to each of the file manager nodes.

Preferably, each of the file manager nodes has a function of receiving the file discard request messages for the respective digital content files transmitted from the file producer nodes, changing the first distributed blockchain ledger such that the digital content files recorded and registered in the first distributed blockchain ledger become unusable, on the basis of the file discard request messages, and enabling the changed first distributed blockchain ledger to be shared by the file manager nodes connected to the blockchain network.

Preferably, each of the file manager nodes may receive the file discard request messages for the respective digital content files transmitted from the file producer nodes and forward the file discard request messages to the file provider nodes and the file seller nodes connected through the communication network such that digital content files corresponding to the file discard request messages are discarded.

Preferably, the blockchain network may be configured to be always online so that transaction information data of each of the digital content files is generated and recorded in the first distributed blockchain ledger at any time.

Preferably, each of the file manager nodes may have a function of receiving the file provision contract information data for each of the digital content files transmitted from the file provider nodes, encrypt the file provision contract information data for each of the digital content files, on the basis of the received information data, and record and register the encrypted file provision contract information data in a second distributed blockchain ledger.

Preferably, each of the file manager nodes may enable the second distributed blockchain ledger in which the encrypted file provision contract information data for each of the digital contents to be shared by a plurality of file manager nodes connected to a blockchain network.

Preferably, the blockchain network may be configured such that the second distributed blockchain ledger in which the encrypted file provision contract information data for each of the digital content files is recorded and registered is stored in a distributed manner as a chain of blocks in storage units of the respective file manager nodes.

Preferably, the blockchain network may be configured to be always online so that transaction information data of each of the digital content files is generated and recorded in the second distributed blockchain ledger at any time.

Preferably, each of the file manager nodes may receive the file use contract information data for each of the digital content files transmitted from the file provider nodes, encrypt the file use contract information data for each of the digital content files on the basis of the received file use contract information data, and record and register the encrypted file use contract information data in a third distributed blockchain ledger.

Preferably, each of the file manager nodes may enable the third distributed blockchain ledger in which the encrypted file use contract information data to be shared by a plurality of file manager nodes connected to a blockchain network.

Preferably, the blockchain network may be configured such that the third distributed blockchain ledger in which the encrypted file use contract information is recorded and registered is stored in a distributed manner as a chain of blocks in storage units of the respective file manager nodes.

Preferably, the blockchain network may be configured to be always online so that transaction information data of each of the digital content files is generated and recorded in the third distributed blockchain ledger at any time.

Preferably, each of the digital content files generated by the file producer nodes may include at least one data file selected from among a video data file, an image data file, an audio data file, and a document data file.

Preferably, in order to download a specific digital content file from one of the file provider nodes that have contracted with at least one of the file seller nodes to provide digital content files including the specific digital content file, each of the file buyer nodes may operate in conjunction with one of the file seller nodes or one of the file provider nodes, thereby receiving a complete copy of the specific digital content file in a manner of receiving pieces of the digital content file from a tracker peer node having file transmission information data required for transmission of the specific digital content file and from a plurality of contribution peer nodes in which the respective pieces of the specific digital content file are stored, in a peer-to-peer communication manner, according to a file transmission option selected by the file buyer node and then using the complete copy of the specific digital content file.

Preferably, the tracker peer node may have the file transmission information data including: hash information data of the specific digital content file; information data of an address list of seeders having a complete copy of the specific digital content file, and information data of an address list of leachers each of which has a copy of a piece of the digital content file.

Preferably, the file transmission service option may include at least one of a network speed option for selecting highest ranked contribution peer nodes for a data transfer rate among the contribution peer nodes; a transmission cost option for selecting least expensive contribution peer nodes among the contribution peer nodes regardless of the data transfer rate; and a sender reliability option for selecting highest ranked contribution peer nodes for sender reliability among the contribution peer nodes.

Preferably, after each of the file buyer nodes receives all the pieces of the specific digital content file from the contribution peer nodes, each of the file buyer nodes may generate transmission transaction result information data for the specific digital content file and transmit the generated transmission transaction result information data to at least one of the file manager nodes connected thereto via the communication network.

Preferably, each of the file manager nodes may provides a service of setting profits of each node involved in the transaction of each of the digital content files, on the basis of the transmission transaction result information data received from the each of the file buyer nodes.

Preferably, each of the file manager nodes may receive the transmission transaction result information data for the specific digital content file, transmitted from each of the file buyer nodes, encrypting the transmission transaction result information data for each of the digital content files, on the basis of the received the transmission transaction result information data, and record and register the encrypted transmission transaction result information data in a fourth distributed blockchain ledger.

Preferably, each of the file manager nodes may enable the fourth distributed blockchain ledger in which the encrypted transmission transaction result information data is recorded and stored to be shared by a plurality of file manager nodes connected to a blockchain network.

Preferably, the blockchain network may be configured such that the fourth distributed blockchain ledger in which the encrypted transmission transaction result information data is recorded and registered is stored in a distributed manner as a chain of blocks in storage units of the respective file manager nodes.

Preferably, the blockchain network may be configured to be always online so that transaction information data of each of the digital content files is generated and recorded in the fourth distributed blockchain ledger at any time.

Preferably, the transmission transaction result information data for the specific digital content file, generated by each of the file buyer nodes may include a Merkle tree root hash value of the specific digital content file, which is calculated by using a Merkle hash tree algorithm, and final transmission transaction history information data.

Preferably, each of the file manager nodes may provide a service of settling license fees and rewards on the basis of the file storage contract information data, the file sale contract information data, the file provision contract information data, and the file use contract information data for the specific digital content file, wherein the license fees include royalties given to each of the file producer nodes, a provision service charge given to each of the file provider nodes, and sales earnings given to each of the file seller nodes, and the rewards include a reward for each of the nodes that have actually contributed to transmission of the specific digital content file, the reward being determined according to a degree of contribution of each of the nodes.

Preferably, each of the file buyer nodes may generate file reproduction result information data for the specific digital content file after receiving and using the specific digital content file from the at least one file provider node which has contracted with the at least one file provider node to provide digital content files.

Preferably, each of the file manager nodes may receive the file reproduction result information data for the specific digital content file, transmitted from each of the file buyer nodes, encrypt the file reproduction result information data for the specific digital content file, on the basis of the received file reproduction result information data, and record and register the encrypted file reproduction result information data in a fifth distributed blockchain ledger.

Preferably, each of the file manager nodes may provide a service of enabling the fifth distributed blockchain ledger in which the encrypted file reproduction result information data is recorded and registered to be shared by a plurality of file manager nodes connected to a blockchain network and providing a service of settling profits of each node on the basis of the file storage contract information data, the file sale contract information data, the file provision contract information data, and the file use contract information for the specific digital content file.

Preferably, the blockchain network may be configured such that the fifth distributed blockchain ledger is stored in a distributed manner as a chain of blocks in storage units of the respective file manager nodes.

Preferably, the blockchain network may be configured to be always online so that transaction information data for each of the digital content files is generated and recorded in the fifth distributed blockchain ledger at any time.

Preferably, each node of the file producer nodes, the file provider nodes, the file seller nodes, the file buyer node, and the file manager node may include at least one of a module, a device, a terminal, and a server.

In order to accomplish the objective of the present invention, another aspect of the present invention provides a data management method of distributing a digital contents file, the data management method being implemented by a system in which at least one file producer node, at least one file supplier node, at least one file seller node, at least one file buyer node, and at least one file manager node are connected to each other via a communication network, the data management method including: (a) by each of the file producer nodes, generating at least one digital content file and transmitting a file registration request message containing file producer information data of a producer node that has generated the at least one content file and file-related information data of each of the generated digital content files, which are required for registration of each of the digital content files, along with file storage contract information data based on a file storage contract with a predetermined file provider node of the file provider nodes in order to store each of the digital content files and file sale contract information data based on a file sale contract with a predetermined seller node of the file seller nodes in order to sell each of the digital content files; (b) by each of the file provider nodes, collecting the digital content files generated by each of the file producer nodes, storing the collected digital content files in a database (DB) format in a storage unit thereof by grouping the digital content files by file producer node or by digital content file, and transmitting file provision contract information based on a file provision contract with a predetermined file seller node of the file seller nodes in order to provide each of the file content files; (c) by each of the file seller nodes, transmitting file use contract information data based on a file use contract with each of the file buyer nodes in order to sell each of the digital content files, in which each of the file seller nodes has a transmission channel for transmitting each of the digital content files stored in each of the file storage units provided in the respective file provider nodes and provides a file sale service for selling the digital content files using the transmission channel thereof; (d) by each of the file buyer nodes, purchasing a specific digital content file in accordance with the file use contract information, on the basis of the file sale service provided by each of the file seller nodes, thereby receiving the specific digital content file from a file provider node which has contracted with each of the file seller nodes to provide digital content files including the specific digital content file; and (e) by each of the file manager nodes, providing a service of (e1) storing and managing the digital content files in a database form by grouping the digital content files by file producer node or digital content file, on the basis of the file registration request message including the file producer information data and the file-related information of each of the digital content files, the file storage contract information data, the file sale contract information data, the file provision contract information data, and the file use contract information data, (e2) processing payment for the specific digital content file by receiving file purchase and use information data for the specific digital content file, received from the at least one file buyer node, and (e3) settling profits of each node involved in the transaction of the specific digital contract, in accordance with the file storage contract information data, the file sale contract information data, the file provision contract information data, and the file use contract information data.

Preferably, in the (e) step, on the basis of the file registration request message including the file producer information data of each of the digital content files and the file-related information of each of the digital content files transmitted from each of the file producer nodes, the file storage contract information data, and the file sale contract information data, the service may be provided such that the file producer information data of each digital content file, the file-related information data of each digital content file, the file storage contract information data, and the file sale contract information data are encrypted, recorded, and registered in a first distributed blockchain ledger, and the first distributed blockchain ledger in which the encrypted information data including the file producer information data, the file-related information data, the file storage contract information data, and the file sale contract information data is recorded and registered is shared by a plurality of file manager nodes connected to a blockchain network.

Preferably, the blockchain network may be configured such that the first distributed blockchain ledger in which the encrypted information data including the file producer information data, the file-related information data, the file storage contract information data, and the file sale contract information data is recorded and registered is stored in a distributed manner as a chain of blocks in storage units of the respective file manager nodes.

The data management method may further include: (f) by each of the file producer nodes, transmitting a file discard request message for each of the digital content files, to each of the file manager nodes; and (g) by each of the file manager nodes, providing a service of changing the first distributed blockchain ledger so that the specific digital content file record and registered in the first distributed blockchain ledger cannot be used, on the basis of the file discard request message transmitted in the (f) step, and enabling the changed first distributed blockchain ledger is shared by the file manager nodes connected to the blockchain network, wherein the (f) step and the (g) step are performed after the (e) step.

Preferably, the data management method may further include: by each of the file manager nodes, transmitting a file discard request message for each of the digital content files to each of the file provider nodes and to each of the file seller nodes through the communication network such that the corresponding digital content files are discarded on the basis of the file discard request message for each of the digital content files transmitted in the (f) step, wherein the transmitting of the file discharged request message is performed after the (g) step.

Preferably, the blockchain network may be configured to be always online so that transaction information data of each of the digital content files is generated and recorded in the first distributed blockchain ledger at any time.

Preferably, in the (e) step, each of the file manager nodes may provide a service of encrypting the file provision contract information data for each of the digital content files, on the basis of the file provision contract information data transmitted in the (b) step, recording and registering the encrypted file provision contract information data in a second distributed blockchain ledger, and enabling the second distributed blockchain ledger to be shared by the plurality of file manager nodes connected to the blockchain network.

Preferably, the blockchain network may be configured such that the second distributed blockchain ledger in which the encrypted file provision contract information data for each of the digital content files is recorded and registered is stored in a distributed manner as a chain of blocks in storage units of the respective file manager nodes.

Preferably, the blockchain network may be configured to be always online so that transaction information data of each of the digital content files is generated and recorded in the second distributed blockchain ledger at any time.

Preferably, in the (e) step, each of the file manager nodes may provide a service of encrypting the file use contract information data for each of the digital content files, on the basis of the file use contract information data transmitted in the (c) step, recording and registering the encrypted file use contract information data in a third distributed blockchain ledger, and enabling the third distributed blockchain ledger to be shared by the plurality of file manager nodes connected to the blockchain network.

Preferably, the blockchain network may be configured such that the third distributed blockchain ledger in which the encrypted file use contract information data for each of the digital content files is recorded and registered is stored in a distributed manner as a chain of blocks in storage units of the respective file manager nodes.

Preferably, the blockchain network may be configured to be always online so that transaction information data of each of the digital content files is generated and recorded in the third distributed blockchain ledger at any time.

Preferably, each of the digital content files generated by each of the file producer nodes in the (a) step may be composed of at least one data file selected from among a video data file, an image data file, an audio data file, and a document data file.

Preferably, when downloading a specific digital content file from a predetermined file provider node of the file provider nodes that have contracted with each of the file seller nodes to provide the specific digital content file in the (d) step, each of the file buyer nodes may operate in conjunction with each of the file seller nodes or each of the file provider nodes, thereby obtaining a complete copy of the specific digital content file in a manner of receiving copies of distributed pieces of the digital content file from a tracker peer node having file transmission information data required for transmission of the specific digital content file and from a plurality of contribution peer nodes in which the pieces of the specific digital content file are stored, in a peer-to-peer communication manner, according to a file transmission option selected by the file buyer node and then using the complete copy of the specific digital content file.

Preferably, the tracker peer node may have the file transmission information data including: hash information data of the specific digital content file; information data of an address list of seeders having a complete copy of the specific digital content file; and information data of an address list of leachers having a copy of a piece of the digital content file.

Preferably, the file transmission service option may include at least one of a network speed option for selecting highest ranked peer nodes for a data transfer rate among the contribution peer nodes, a transmission cost option for selecting least expensive peer nodes among the contribution peer nodes regardless of the data transfer rate, and a sender reliability option for selecting highest ranked peer nodes for reliability among the contribution peer nodes.

Preferably, after each of the file buyer nodes receives the copies of all the pieces of the specific digital content file from the contribution peer nodes, each of the file buyer nodes may generate transmission transaction result information data for the specific digital content file and transmit the generated transmission transaction result information data to at least one of the file manager nodes connected thereto via the communication network.

Preferably, each of the file manager nodes may provide a service of settling profits of each node for behavior of transmitting the specific digital content file, on the basis of the transmission transaction result information data received from each of the file buyer nodes.

Preferably, the data management method may further include: by each of the file manager nodes, providing a service of encrypting the transmission transaction result information data for each of the digital content files, on the basis of the transmission transaction result information data for each of the specific digital content files, the data being transmitted from each of the file buyer nodes, recording and registering the encrypted transmission transaction result information data in a fourth distributed blockchain ledger, and enabling the fourth distributed blockchain ledger to be shared by a plurality of file manager nodes connected to a blockchain network.

Preferably, the blockchain network may be configured such that the fourth distributed blockchain ledger in which the encrypted transmission transaction result information data for each of the digital content files is recorded and registered is stored in a distributed manner as a chain of blocks in storage units of the respective file manager nodes.

Preferably, the blockchain network may be configured to be always online so that transaction information data of each of the digital content files is generated and recorded in the fourth distributed blockchain ledger at any time.

Preferably, the transmission transaction result information data generated by each of the file buyer nodes for the specific digital content file may include a Merkle tree root hash value of the specific digital content file, which is calculated by using a Merkle hash tree algorithm, and final transmission transaction history information data.

Preferably, in the (e) step, each of the file manager nodes may provide a service of settling license fees and rewards, on the basis of the file storage contract information data, the file sale contract information data, the file provision contract information data, and the file use contract information data for the specific digital content file, wherein the license fees include royalties to be given to each of the file producer nodes, a provision service charge to given to each of the file provider nodes, and sales earnings to be given to each of the file seller nodes, and the rewards include a reward for each of the nodes that has actually contributed to transmission of the specific digital content file, the reward being determined according to a degree of contribution of each of the nodes.

Preferably, the data management method may further include: by each of the file buyer nodes, generating file reproduction result information data for the specific digital content file and transmitting the generated file reproduction result information data for the specific digital content file to each of the file manager nodes after each of the file buyer nodes receives and uses the specific digital content file transmitted from one of the file provider nodes which have contracted with the at least one file provider node to provide digital content files in the (d) step.

Preferably, the data management method may further include: by each of the file manager nodes, providing a service of encrypting the file reproduction result information data for the specific digital content file, on the basis of the file reproduction result information data received from each of the file buyer nodes for the specific digital content file, of recording and registering the encrypted file reproduction result information data in a fifth distributed blockchain ledger, and enabling the fifth distributed blockchain ledger to be shared by a plurality of file manager nodes connected to a blockchain network.

Preferably, the blockchain network may be configured such that the fifth distributed blockchain ledger in which the encrypted file reproduction result information data is recorded and registered is stored in a distributed manner as a chain of blocks in storage units of the respective file manager nodes.

Preferably, the blockchain network may be configured to be always online so that transaction information data for each of the digital content files is generated and recorded in the fifth distributed blockchain ledger at any time.

Preferably, each of the file producer nodes, the file provider nodes, the file seller nodes, the file buyer node, and the file manager node may include at least one of a module, a device, a terminal, and a server.

In order to accomplish the objective of the present invention, a further aspect of the present invention provides a computer-readable recording medium in which a program to execute the data management method is stored.

The data management method of distributing a digital content file, according to the present invention, may be implemented as a computer-readable code recorded in a computer-readable recording medium. The computer-readable recording media include all kinds of recording devices in which data that can be read by a computing system can be recorded.

Specifically, examples of the computer-readable medium include a ROM, a RAM, a CD-ROM, a magnetic table, a hard disk, a floppy disk, a mobile storage device, a nonvolatile memory (also called flash memory), an optical data storage device, etc.

The data management system and method of distributing a digital content file, according to the present invention, are based on an on-off hybrid blockchain network. That is, transactional information data having a large volume is processed on an off-blockchain network and only final results of the transactions are recorded on an on-blockchain network. Therefore, it is possible to increase the number of transactions that can be processed per second, resulting in a large volume of data being able to be distributed. In addition, it is possible to encourage every node to participate in distribution of digital content files as file senders by rewarding each participant for behavior of transmitting a digital content file. That is, the data management system and method enables implementation of a distribution structure in which each participant contributing to distribution of digital content files can obtain profits.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a block diagram illustrating the overall configuration of a data management system for distributing a digital content file, according to an embodiment of the present invention;

FIG. 2 is a block diagram illustrating the overall configuration of a data management system for distributing a digital content file, according to another embodiment of the present invention; and

FIGS. 3 and 4 are flowcharts illustrating the overall flow of a data management method of distributing a digital content file, according to an embodiment of the present invention.

### DETAILED DESCRIPTION OF THE DISCLOSURE

The above and other objects, features, and advantages of the present invention will become apparent to those skilled in the art from the exemplary embodiments described below and the attached drawings, so that those skilled in the art can implement the technical sprit of the present invention on the basis of the description provided below. Further, in describing the exemplary embodiments of the present invention, well-known functions or constructions will not be described in detail since they may obscure the gist of the present invention.

Terms such as a first term and a second term may be used for explaining various constitutive elements, but the constitutive elements should not be limited to these terms. These terms are used only for the purpose for distinguishing a constitutive element from another constitutive element. For example, a first constitutive element may be referred as a second constitutive element, and the second constitutive element may be also referred to as the first constitutive element. The terminology used herein is for the purpose of describing particular embodiments only and is not intended to limit the invention. As used herein, the singular forms “a”, “an”, and “the” are intended to include the plural forms as well, unless the context clearly indicates otherwise.

While the present invention has been described in connection with what is presently considered to be the most practical and preferred embodiment, it is to be understood that the invention is not limited to the disclosed embodiments. In addition, in certain cases, there may be a term arbitrarily selected by the inventor(s), and the meaning thereof will be described in detail in the description of the present invention. Therefore, the term used in the present invention should not be defined not on the name of a simple term but should be defined on the basis of the meaning of the term and the entire contents of the present invention.

It will be further understood that the terms “comprises”, “comprising,”, “includes”, and/or “including”, when used herein, specify the presence of stated features, integers, steps, operations, elements, and/or components, but do not preclude the presence or addition of one or more other features, integers, steps, operations, elements, components, and/or groups thereof. Also, the terms “≈part”, “≈unit”, “module”, “apparatus” and the like mean a unit for processing at least one function or operation and may be implemented by a combination of hardware and/or software.

Hereinafter, exemplary embodiments of the present invention will be described in detail with reference to the accompanying drawings. However, the following embodiments of the present invention may be modified into various other forms, and the scope of the present invention is not limited to the following embodiments. The exemplary embodiments of the present invention are provided to enable those skilled in the art to more easily and completely understand the present invention.

Each block of the accompanying block diagrams and combinations of steps of the flowcharts may be performed by computer program instructions (execution engines). These computer program instructions may be embedded in a processor of a general purpose computer, a special purpose computer, or other programmable data processing apparatus. The instructions that are executed by the processor of the computer or other programmable data processing equipment create means for performing the functions described in each block of the block diagram or each step of the flowchart. These computer program instructions may be stored in a computer-usable or computer-readable memory capable of directing a computer or other programmable data processing apparatus to implement a function in a particular manner. Thus, the instructions stored in the computer-usable or computer-readable memory are also capable of producing manufacturing items containing instruction means for performing the functions described in each block of the block diagram or each step of the flowchart.

Computer program instructions may also be loaded onto a computer or other programmable data processing equipment so that a series of operating steps may be performed on a computer or other programmable data processing equipment to create computer-executable processes. The instructions that can be executed on a computer or other programmable data processing equipment may provide the steps for executing the functions described in each block of the block diagram and at each step of the flowchart.

In addition, each block or step may represent a portion of a module, segment, or code that includes one or more executable instructions for executing specific logical functions. It should be noted that the functions that are described in the blocks or steps may be performed in an order different from the description order in some alternative embodiments. For example, two successive blocks or steps may actually be performed substantially concurrently, or may even be performed in the reverse order of the functions as required.

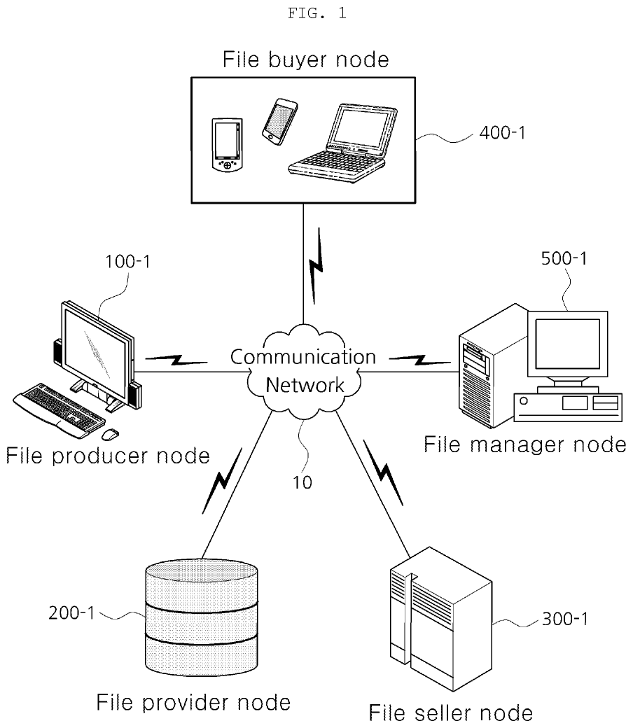

FIG. 1 is a block diagram illustrating the overall configuration of a data management system for distributing a digital content file, according to an embodiment of the present invention. Referring to FIG. 1, the data management system includes a file producer node 100-1, a file provider node 200-1, a file seller node 300-1, a file buyer node 400-1, and a file manager node 500-1 which are all connected to each over via a communication network 10.

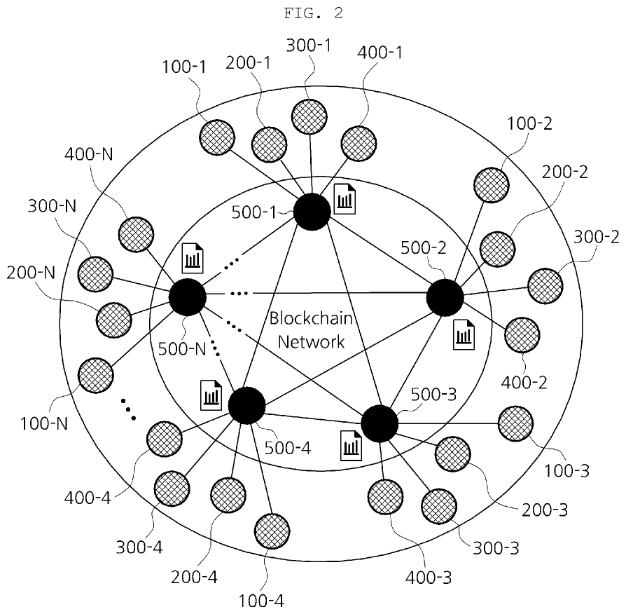

FIG. 2 is a data management system for distributing a digital content file, according to another embodiment of the present invention. The system includes a plurality of file producer nodes 100-1 to 100-N, a plurality of file provider nodes 200-1 to 200-N, a plurality of file seller nodes 300-1 to 300-N, a plurality of file buyer nodes 400-1 to 400-N, and a plurality of file manager nodes 500-1 to 500-N which are all connected to each other via a communications network 10.

Although not explicitly illustrated in FIG. 2, the file producer nodes 100-1 to 100-N, the file provider nodes 200-1 to 200-N, the file seller nodes 300-1 to 300-N, the file buyer nodes 400-1 to 400-N, and the file manager nodes 500-1 to 500-N are connected to each other via the communication network 10 represented by solid lines.

The communication network 10 is, for example, an Ethernet or a mobile communication network. Alternatively, the communication network 10 may be a large high-speed infrastructural communication network enabling large-volume and long-distance transmission of voice and data. Further alternatively, the communication network 10 may be a next-generation wireless network such as WiFi, WiBro, or WiMAX for an Internet service or a high-speed multimedia provision service.

The Internet refers to a worldwide open network architecture using the TCP/IP protocol and supports various upper-layer services such as hyper text transfer protocol (HTTP), Telnet, file transfer protocol (FTP), domain name system (DNS), simple main transfer protocol (SMTP), simple network management protocol (SNMP), network file service (NFS), and network information service (NIS). The Internet enables each of the file producer nodes 100-1 to 100-N, each of the file provider nodes 200-1 to 200-N, each of the file seller nodes 300-1 to 300-N, and each of the file buyer nodes 400- to 400-N are connected with a corresponding one of the file manager nodes 500-1 to 500-N. The internet may be a wired or wireless network. Alternatively, the internet may be a core network integrated with a wired public network, a wireless mobile communication network, or a portable internet.

When the communication network 10 is a mobile communication network, it may be a synchronous mobile communication network or an asynchronous mobile communication network. An example of the asynchronous mobile communication network is a wideband code division multiple access (WCDMA)-scheme communication network. In this case, although not illustrated in the drawings, the mobile communication network includes, for example, a radio network controller (RNC). Although the WCDMA network is described as an example of the mobile communication network, the present invention is not limited thereto. The mobile communication network may be a next generation communication network such as a 3G LTE network, a 4G network, a 5G network, or an IP network. The communication network 10 functions to relay signals and data between the file manager nodes 500-1 to 500-N and the respective file producer nodes 100-1 to 100-N, between the file manger nodes 500-1 to 500-N and the respective file provider nodes 200-1 to 200-N, between the file manager nodes 500-1 to 500-N and the respective file seller nodes 300-1 to 300-N, and between the file manager nodes 500-1 to 500-N and the respective file buyer nodes 400-1 to 400-N.

Referring to FIGS. 1 to 2, each of the data management systems according to exemplary embodiments of the present invention includes at least one file producer node 100-1 to 100-N, at least one file provider node 200-1 to 200-N, at least one file seller node 300-1 to 300-N, at least one file buyer node 400-1 to 400-N, and at least one of file manager node 500-1 to 500-N. Components illustrated in FIGS. 1 and 2 are not essential. Each of the data management systems according to exemplary embodiments of the present invention may include more or fewer components than those illustrated in FIG. 1 or 2 for distributing a digital content file. In the following description, the phrase “at least one” represents a single element, or two or more elements. Although the phrase “at least one” is omitted, this applies to each component, signal, step, element, member, unit, or the like used in the present invention.

Hereinafter, the components of the data management system for distributing a digital content file, according to an embodiment of the present invention, will be described in detail.

The file producer nodes 100-1 to 100-N are connected to the file provider nodes 200-1 to 200-N, respectively, to the file seller nodes 300-1 to 300-N, respectively, to the file buyer nodes 400-1 to 400-N, respectively, and/or to the file manager nodes 500-1 to 500-N, respectively.

Each of the file producer nodes 100-1 to 100-N generates at least one digital content file. For registration of the generated digital content file, each of the file producer nodes 100-1 to 100-N transmits a file registration request message, along with file storage contract information data based on file storage contracts with predetermined file provider nodes 200-1 to 200-N and file sale contract information data based on file sale contracts with predetermined fine seller nodes 300-1 to 300-N, to each of the file manager nodes 500-1 to 500-N. The file registration request message includes file producer information data that is information on each file producer node which has produced a digital content file and file-related information data that is information on each digital content file.

In addition, each of the file producer nodes 100-1 to 100-N transmits a file discard request message for destroying a digital content file to the file manager nodes 500-1 to 500-N.

The digital content file generated by the file producer nodes 100-1 to 100-N includes at least one data file selected among a video data file, an image data file, an audio data file, and a document data file.

Each of the file provider nodes 200-1 to 200-N is connected to each of the file producer nodes 100-1 to 100-N, each of the file seller nodes 300-1 to 300-N, each of the file buyer nodes 400-1 to 400-N, and etch of the file manager nodes 500-1 to 500-N via the communication network 10.

Each of the file provider nodes 200-1 to 200-N collects the digital content files generated by the file producer nodes 100-1 to 100-N, and stores the collected digital content files in a database form for each file producer node and/or for each digital content file, in a predetermined file storage unit (not illustrated).

In addition, each of the file provider nodes 200-1 to 200-N transmits file provision contract information data based on file provision contracts with predetermined file seller nodes 300-1 to 300-N, to the file manager nodes 500-1 to 500-N.

Each of the file seller nodes 300-1 to 300-N is connected to the file producer nodes 100-1 to 100-N, the file provider nodes 200-1 to 200-N, the file buyer nodes 400-1 to 400-N, and/or the file manager nodes 500-1 to 500-N via the communication network 10.

Each of the file seller nodes 300-1 to 300-N is allocated at least one transmission channel for transmission of the digital content files stored in file storage units provided in the respective file provider nodes 200-1 to 200-N, and provides a file sale service for selling the digital content files through the transmission channel.

In addition, each of the file seller nodes 300-1 to 300-N transmits file use contract information data based on file use contracts with the file buyer nodes 400-1 to 400-N, to the file manager nodes 500-1 to 500-N in order to sell the digital content files.

Each of the file buyer nodes 400-1 to 400-N is connected to the file producer nodes 100-1 to 100-N, the file provider nodes 200-1 to 200-N, the file seller nodes 300-1 to 300-N, and/or the file manager nodes 500-1 to 500-N via the communication network 10.

Each of the file buyer nodes 400-1 to 400-N purchases a specific digital content file according to file use contract information data based on a file use contract with a corresponding one of the file seller nodes 300-1 to 300-N on the basis of the file sale service provided by each of the file seller nodes 300-1 to 300-N, receives the specific digital content file from a corresponding one of the file provider nodes 200-1 to 200-N which have contracted with each of the file seller nodes 300-1 to 300-N to provide digital files including the specific digital content file, and uses (i.e., playbacks or reproduces) the specific digital content file.

When one of the file buyer nodes 400-1 to 400-N receives the specific digital content file from the corresponding one of the file provider nodes 200-1 to 200-N which have contracted with the file seller nodes 300-1 to 300-N to provide digital content files including the specific digital content file, the file buyer node operates in conjunction with the corresponding file seller node and/or the corresponding file provider node to receive copies of all pieces of the specific digital content file on a peer-to-peer basis, via one tracker peer node (not illustrated) having information data required for transmission of the specific digital content file and via multiple contribution peer nodes (not illustrated), each storing a copy of a piece of the specific digital content file, in accordance with a file transmission service option selected by the file buyer node. The file buyer node then uses the received specific digital content file.

Here, the tracker peer node has the information data including: hash information data of the specific digital content file; information data of an address list of seeders having a complete copy of the specific digital content file, and information data of an address list of leachers, each having a copy of a piece of the specific digital content file.

Regarding the file transmission service option, there are three options: a network speed option for selecting highest ranked contribution peer nodes for a data transfer rate; a transmission cost option for selecting least expensive contribution peer nodes regardless of the data transfer rate; and/or a reliable sender option for selecting highest ranked contribution peer nodes for sender reliability.

In the embodiments of the present invention, the data management system includes the tracker peer node that is a stand-alone node. However, the present invention is not limited thereto. That is, the file buyer nodes 400-1 to 400-N themselves may function as tracker peer nodes.

In addition, when one of the file buyer nodes 400-1 to 400-N receives all the pieces of the pieces of the specific digital content file from the respective contribution peer nodes, the file buyer node generates transmission transaction result information data for the specific content file, and transmits it to a corresponding one of the file manager nodes 500-1 to 500-N connected via the communication network 10.

In this case, the transmission transaction result information data generated by the file buyer node 400-1, . . . , or 400-N for the specific digital content file includes a Merkle tree root hash value of the specific digital content file, which is calculated using a Merkle hash tree algorithm, and final transmission transaction history information data.

In other words, each of the file buyer nodes 400-1 to 400N processes transmission data on the basis of an on-and-off hybrid blockchain network. That is, transactional information data having a large volume (for example, transmission transaction result information for a specific digital content file, etc.) is processed on an off-blockchain network, and only the final result (for example, final transmission transaction history information, etc.) is processed on an on-blockchain network. With the use of the on-and-off hybrid blockchain network, it is possible to increase the number of transactions that can be processed per second, which enables distribution of a large digital content file. In addition, it is possible to encourage each node to participate in distribution of digital content files by rewarding each participant for behavior of transmitting a piece of a digital content file. As a result, each participant can get a reward to make profits by participating in transmission of a digital content file.

The on-blockchain network refers to a blockchain network that is always online to enable occurrence of a transaction at any time and recording of the transaction in a blockchain ledger at any time. The off-blockchain network refers to a blockchain network that is temporally online during only a duration during which a digital content file is transmitted and in which a transmission transaction (hereinafter, referred to as a micro-transaction) of a piece of the digital content file is recorded during only the online duration.

That is, when the transmission of all the distributed pieces (i.e., a complete copy) of the digital content file is finished, a completed transaction (e.g., final transmission transaction history information, etc.) is generated and recorded on the on-blockchain network.

When one of the file buyer nodes 400-1 to 400-N receives the specific digital fine from one of the file provider nodes 200-1 to 200-N that have contracted with the file seller nodes 300-1 to 300-N to provide digital content files including the specific digital content file and uses the received specific digital content file, for use of the specific digital file, the file buyer node generates file reproduction result information data for the specific digital content file and transmits the generated file reproduction result information to a corresponding one of file manager nodes 500-1 to 500-N.

In addition, when one of the file buyer nodes 400-1 to 400-N purchases and uses a specific digital content file, the file buyer node generates purchase and user information data for the specific digital content file and transmits it to a corresponding one of the file manager nodes 500-1 to 500-N connected via the communication network 10.

In addition, each of the file buyer nodes 400-1 to 400-N transmits file use contract information data based on a file use contract with one of the file seller nodes 300-1 to 300-N, to a corresponding one of the file manager nodes 500-1 to 500-N.

Each of the file manager nodes 500-1 to 500-N is connected with the file producer nodes 100-1 to 100-N, the file provider nodes 200-1 to 200-N, the file seller nodes 300-1 to 300-N, and/or the file buyer nodes 400-1 to 400-N, via the communication network 10.

Each of the file manager nodes 500-1 to 500-N is connected to the file producer nodes 100-1 to 100-N, the file provider nodes 200-1 to 200-N, and/or the file seller nodes 300-1 to 300-N, thereby receiving a file registration request message including file producer information data of each producer node and file-related information of each digital content file, along with file storage contract information data and file sale contract information data, and also receiving file provision contract information data, and/or file use contract information data, and stores and manages the received information data in the form of databases for each digital content file and/or for each file producer node.

In addition, each of the file manager node 500-1 to 500-N receives purchase and use information data for a specific digital content file from the corresponding one of the file buyer nodes 400-1 to 400-N, processes payment for the specific digital content file on the basis of the purchase and use information data, and settles profits or revenues of each node on the basis of the file storage contract information data, the file sale contract information data, the file provision contract information data, and/or the file use contract information data.

In addition, each of the file manager nodes 500-1 to 500-N receives a file registration request message containing file producer information data of each producer node and file-related information data of each digital content file transmitted from each of the file producer nodes 100-1 to 100-N, along with the file storage contract information data and/or the file sale contract information data. Next, each of the file manager nodes 500-1 to 500-N has a function of encrypting the file producer information data, the file-related information data, the file storage contract information data, and/or the file sale contract information data, and then recording and registering the encrypted data in a first distributed blockchain ledger.

The term “blockchain” used in the description herein refers to a data management technology in which continuously growing data is recorded on a per block basis and each of the nodes that make up a peer-to-peer (P2P) network manages the blocks of the data in the form of a chain of blocks, or refers to data itself having a blockchain data structure.

Blockchain data that is a chain of data blocks is used in the form of distributed ledgers at respective nodes without using a centralized system.

Each blockchain node constituting a blockchain network manages the blocks of data in a data structure form. Here, the hash value of an immediately previous block is recorded in a current block, and the previous block is referred to on the basis of the hash value for the next transaction. Therefore, as the blocks are piled up over time, forgery and falsification of transaction data recorded in the blocks become more difficult, and the reliability of the transaction data recorded in each block is improved.

Throughout the description of exemplary embodiments of the present invention, blockchain data refers to data held in each of the blockchain nodes constituting a blockchain network in which at least one block is composed of data having a chain-type data structure.

When the data recorded in each of the blocks is transaction data, the blockchain data can be used as a distributed branch of the ledger. However, the type of data recorded in each block may vary.

The term “blockchain network” refers to a P2P structure network composed of a plurality of blockchain nodes that operates on the basis of a blockchain algorithm.

The term “blockchain node” refers to an element of a blockchain network. The blockchain node maintains and manages the blockchain data on the basis of the blockchain algorithm. The blockchain node is implemented as a single computing device in the embodiment. Alternatively, the blockchain node may be implemented as a virtual machine or the like. When the blockchain node is implemented as a virtual machine, multiple blockchain nodes can be provided in a single computing device.

As described above, in the description of exemplary embodiments of the present invention, the blockchain is a public transaction book and is a technique for preventing hacking that may occur when a transaction for a specific digital content file is made. The blockchain is a kind of distributed database (DB) and refers to a data record list in which the number of records increases with time. The blockchain is tamper-proof to the operators of distributed nodes and mandatorily encrypts the records of transactions within a data record list. Further, the blockchain is operated by a computer in which a blockchain software application is executable.

The blockchain structure is based on the consensus convergence algorithm that allows a large number of nodes to keep the latest version of the data of distributed ledgers stored in the respective nodes. This structure has problems of allowing the nodes to operate anonymously, causing the nodes to be poorly connected, and even allowing untrusted operators to participate.

Additionally, each of the file manager nodes 500-1 to 500-N has a function of sharing the first distributed blockchain ledger in which the encrypted data including the file producer information data, the file-related information data, the file storage contract information data, and/or the file sales contract information for each digital content file is recorded and registered, with the other file manager nodes 500-1 through 500-N that are connected to the blockchain network.

In addition, the blockchain network is configured such that the first distributed blockchain ledger in which the encrypted data including the file producer information data, the file-related information data, the file storage contract information data, and/or the file sale contract information for each digital content file are recorded and registered is stored in a distributed manner in the form of a chain of data blocks in the blockchain storage units (not illustrated) of the file manager nodes 500-1 to 500-N.

In addition, the blockchain network is an on-blockchain network that is always online so that the transaction information data of each contract of each digital content file contract can be generated and recorded in the first distributed blockchain ledger at any time.

In addition, the blockchain networks are established on a per country basis, on a per domestic region basis, and/or a per service-specific network basis.

In addition, each of the file manager nodes 500-1 to 500-N has a function of receiving file discard request messages for respective digital content files from the file producer nodes 100-1 to 100-N, changing the first distributed block chain ledger on the basis of the file discard request messages such that the digital content files corresponding to the respective file discard request messages cannot be used, and sharing the changed first distributed blockchain ledger with the other file manager nodes 500-1 to 500-N connected to the blockchain network.

In addition, each of the file manager nodes 500-1 to 500-N has a function of receiving file discard request message for respective digital content files from the file producer nodes 100-1 to 100-N, and forwarding the file discard request messages for the respective digital content files to the corresponding nodes of the file provider nodes 200-1 to 200-N and/or the file seller nodes 300-1 to 300-N connected via the communication network 10 so that the digital content files corresponding to the file discard request messages can be discarded.

In addition, each of the file manager nodes 500-1 to 500-N has a function of receiving file provision contract information data for each of the digital content files transmitted from the file provider nodes 200-1 to 200-N, encrypting the file provision contract information data for each of the digital content files, and recording and registering the encrypted file provision contract information data in a second distributed blockchain ledger.

In addition, each of the file manager nodes 500-1 to 500-N has a function of sharing the second distributed blockchain ledger in which the encrypted file provision contract information data for each of the digital content files is recorded and registered, with the other file manager nodes 500-1 to 500-N connected to the blockchain network.

In addition, the blockchain network is preferably configured such that the second distributed blockchain ledger in which the encrypted file provision contract information data for each of the digital content files is recorded and registered is stored in a distributed manner in the block chain storage units (not illustrated) of the respective file manager nodes 500-1 to 500-N.

In addition, the blockchain network is an on-blockchain network that is always online so that the transaction information data of each contract of each digital content file contract can be generated and recorded in the second distributed blockchain ledger at any time.

In addition, each of the file manager nodes 500-1 to 500-N has a function of receiving file use contract information data for each of the digital content files transmitted from each of the file seller nodes 300-1 to 300-N and/or each of the file provider nodes 400-1 to 400-N, encrypting the file use contract information data for each of the digital content files, and recording and registering the encrypted file use contract information data in a third distributed blockchain ledger.

In addition, each of the file manager nodes 500-1 to 500-N has a function of sharing the third distributed blockchain ledger in which the encrypted file use contract information data for each of the digital content files is recorded and registered, with the other file manager nodes 500-1 through 500-N connected to the blockchain network.

In this case, the blockchain network is preferably configured such that the third distributed blockchain ledger in which the encrypted file use information data for each of the digital content files is recorded and registered, is stored in a distributed manner in the blockchain storage units (not illustrated) of the respective file manager nodes 500-1 to 500-N.

In addition, the blockchain network is an on-blockchain network that is always online so that the transaction information data of each contract of each digital content file can be generated and recorded in the third distributed blockchain ledger at any time.

In addition, each of the file manager nodes 500-1 to 500-N provides a service of settling profits of each node involved in transmission of each of the digital content files on the basis of the transmission transaction result information data transmitted from each of the file buyer nodes 400-1 to 400-N for the specific digital content file.

In addition, each of the file manager nodes 500-1 to 500-N has a function of receiving transmission transaction result information data transmitted from each of the file buyer nodes 400-1 to 400-N for the specific digital content file, encrypting the transmission transaction result information data for each of the digital content files, and recording and registering the encrypted transmission transaction result information data in a fourth distributed blockchain ledger.

In addition, each of the file manager nodes 500-1 to 500-N provides a service of sharing the fourth distributed blockchain ledger in which the encrypted transmission transaction result information data for each of the digital content files is recorded and registered, with the other file manager nodes 500-1 through 500-N connected to the blockchain network.

In this case, the blockchain network is preferably configured such that the fourth distributed blockchain ledger in which the encrypted transmission transaction result information data for each of the digital content files is recorded and registered is stored in a distributed manner in the form of a chain of blocks, in the blockchain storage units (not illustrated) of the respective file manager nodes 500-1 to 500-N.

In addition, the blockchain network is an on-blockchain network that is always online so that the transaction information data of each contract of each digital content file can be generated and recorded in the fourth distributed blockchain ledger at any time.

In addition, each of the file manager nodes 500-1 to 500-N has a function of providing a service of settling license fees for each of the digital content files and rewards for behavior of transmitting each of the digital content files, on the basis of the file storage contract information data, the file sale contract information data, the file provision contract information data and/or the file use contract information data, for a specific digital content file. In this case, the license fees include royalties given to a relevant one of the file producer nodes 100-1 to 100-N, a provision service fee given to a relevant one of the file provider nodes 200-1 to 200-N, and a sales revenue given to a relevant one of the file seller nodes 300-1 to 300-N, for the specific digital content file. The rewards are given to actual file senders (for example, contribution peer nodes) of the specific digital content file as file transmission costs according to a degree of contribution of each file sender.

In addition, each of the file manager nodes 500-1 to 500-N has a function of receiving file reproduction result information data transmitted from each of the file buyer nodes 400-1 to 400-N for the specific digital content file, encrypting the file reproduction result information data for the specific digital content file, and recording and registering the encrypted file reproduction result information data in a fifth distributed blockchain ledger.

In addition, each of the file manager nodes 500-1 to 500-N provides a service of sharing the fifth distribution blockchain ledger in which the encrypted file reproduction result information data for the specific digital content file is recorded and registered with the other file manager nodes 500-1 to 500-N connected to the blockchain network. In addition, each of the file manager nodes 500-1 to 500-N provides a service of settling profits of each node involved in the transaction of the specific digital content file on the basis of the file storage contract information data, the file sale contract information data, the file provision contract information data, and/or the file use contract information for the specific digital content file.

In this case, the blockchain network is preferably configured such that the fifth distributed blockchain ledger in which the encrypted file reproduction result information data for each of the digital content file is recorded and registered is stored, in a distributed manner in the form of a chain of data blocks, in the blockchain storage units (not illustrated) of the respective file manager nodes 500-1 to 500-N.

In addition, the blockchain network is an on-blockchain network that is always online so that the transaction information data of each contract of each digital content file can be generated and recorded in the fifth distributed blockchain ledger at any time.

Preferably, every node of the file producer nodes 100-1 to 100-N, the file provider nodes 200-1 to 200-N, the file seller nodes 300-1 to 300-N, the file buyer nodes 400-1 to 400-N, and the file manager nodes 500-1 to 500-N is composed of at least one of a module, a device, a terminal, and a server.

In the exemplary embodiments of the present invention, when every node of the file producer nodes 100-1 to 100-N, the file provider nodes 200-1 to 200-N, the file seller nodes 300-1 to 300-N, the file buyer nodes 400-1 to 400-N, and the file manager nodes 500-1 to 500-N is composed of a terminal, the terminal is preferably a mobile terminal device performing communications through a wireless Internet or a mobile Internet. Examples of the mobile terminal device include a smart phone, a smart pad, and a smart note. Alternatively, the terminal may refer to any wired or wireless appliance/communication device having a user interface (UI) for connection to each of the nodes described above. For example, a personal computer (PC), a palm PC, a mobile play station, a digital multimedia broadcasting phone having a communication function, a table PC such as an iPad, or the like may be used as the terminal.

On the other hand, when every node of the file producer nodes 100-1 to 100-N, the file provider nodes 200-1 to 200-N, the file seller nodes 300-1 to 300-N, the file buyer nodes 400-1 to 400-N, and the file manager node 500-1 to 500-N is a server, the server may be implemented as a computer that can be connected to a remote server or a remote terminal through the communications network 10. Here, the computer refers to a computer in which a web browser is mounted. Specifically, the computer may be a notebook computer, a desktop computer, or a laptop computer.

On the other hand, in the exemplary embodiments of the present invention, each of the first to fifth distributed blockchain ledger is implemented as a single distributed blockchain ledger. Alternatively, each of the first to fifth distributed blockchain ledgers may be composed of multiple distributed blockchain ledgers.

Hereinafter, a file management method of distributing a digital content file, according to an embodiment of the present invention, will be described.

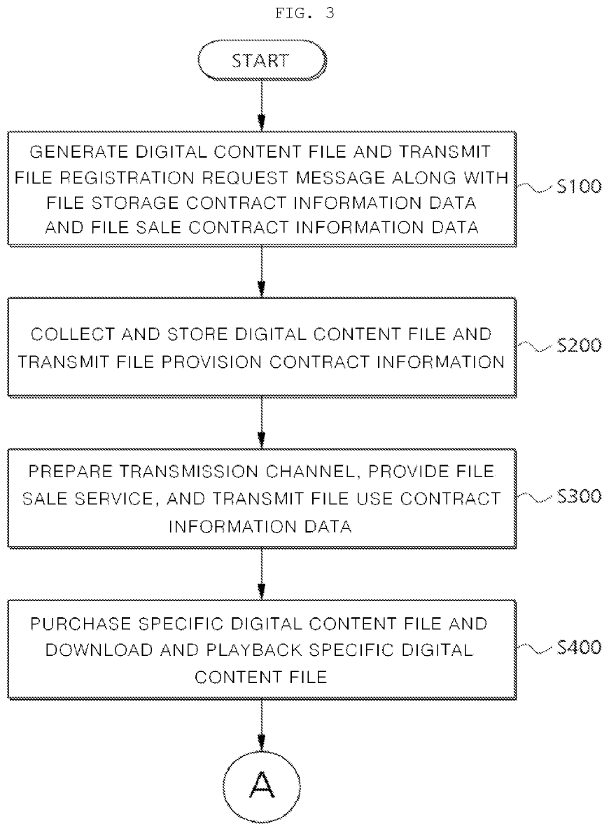

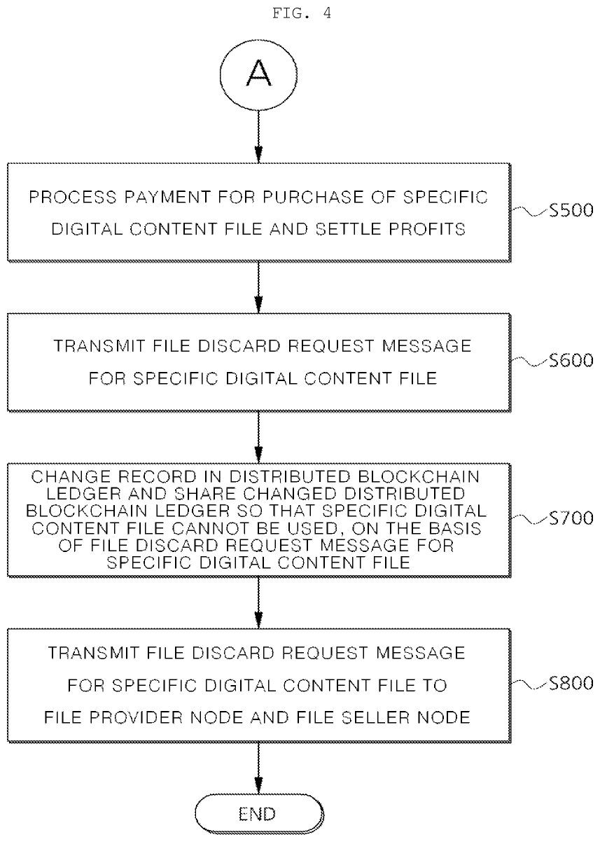

FIGS. 3 and 4 are flowcharts illustrating the overall flow of a data management method of distributing a digital content file, according to an embodiment of the present invention.

Referring to FIGS. 1 to 4, according to the embodiment of the present invention, the file management method includes processing steps described below. First, in Step 5100, each file producer nodes 100-1 to 100-N generates at least one digital content file and transmits a file registration request message to each file manager node 500-1 to 500-N, along with file storage contract information data based on file storage contracts with predetermined file provider nodes 200-1 to 200-N and file sale contract information data based on file sale contracts with predetermined file seller nodes 300-1 to 300-N. Each of the digital content files generated in Step 5100 by the file producer nodes 100-1 to 100-N preferably includes at least one data file such as a video data file, an image data file, an audio data file, and a document data file.

Next, in Step 5200, each of the file provider nodes 200-1 to 200-N collects the digital content files generated in Step 5100 and stores the digital content files in the form of a database for each digital producer node or for each digital content file in a storage unit (not illustrated) and transmits file provision contract information based on file provision contracts with predetermined file seller nodes 300-1 to 300-N, to each of the file manger nodes 500-1 to 500-N.

Next, in Step 5300, each of the file seller nodes 300-1 to 300-N provided with at least one transmission channel for transmission of the digital content files provides a file sale service to sell each of the digital content files through the transmission channel. Then, each of the file seller nodes 300-1 to 300-N transmits file use contract information based on file use contracts with file buyer nodes 400-1 to 400-N for to each of the file manger nodes 500-1 to 500-N.

Next, in Step 5400, each of the file buyer nodes 400-1 to 400-N purchases a specific digital content file according to the file use contract information, on the basis of the file sale service provided in Step 5300. After the payment procedure for the purchase is performed, each of the file buyer nodes 400-1 to 400-N receives the specific digital content file from one of the file provider nodes 200-1 to 200-N which have contracted with each of the file seller nodes 300-1 to 300-N to provide digital content files including the specific digital content file, and uses the received specific digital content file.

In Step 5400, at the time of receiving the specific digital content file from one of the file provider nodes 200-1 to 200-N which have contracted with each of the file seller nodes 300-1 to 300-N to provide digital content files including the specific digital content file, each of the file buyer nodes 400-1 to 400-N operates in conjunction with one of the file seller nodes 300-1 to 300-N and/or one of the file provider nodes 200-1 to 200-N, thereby receiving copies of all pieces of the specific digital content file on a peer-to-peer basis, via one tracker peer node (not illustrated) having information data required for transmission of the specific digital content file and via multiple contribution peer nodes (not illustrated) in which the copies of the pieces of the specific digital content file are respectively stored, according to any one file transmission service option selected by the file buyer node. The file buyer node then uses a complete copy of the specific digital content file by integrating all the copies of the pieces of the specific digital content file.

Here, the tracker peer node has information data required for transmission of the specific digital content file, in which the information data includes; hash information data of the specific digital content file; information data of an address list of seeders having a complete copy of the specific digital content file, and information data of an address list of leachers, each having a copy of a piece of the specific digital content file.

The file transmission service options include a network speed option for selecting highest ranked contribution peer nodes for a data transfer rate, a transmission cost option for selecting least expensive contribution peer nodes, and/or a reliable sender option for selecting highest ranked contribution peer nodes for sender reliability.

In addition, after one of the file buyer nodes 400-1 to 400-N receives the copies of all the pieces of the specific digital content file from the respective contribution peer nodes, the file buyer node generates transmission transaction result information data for the specific content file, and transmits it to the file manager nodes 500-1 to 500-N connected thereto via the communication network 10.

In addition, the data management method may further include a processing step in which each of the file manager nodes 500-1 to 500-N provides a service of settling profits of each node involved in distribution of the specific digital content file on the basis of the transmission transaction result information data transmitted from each of the file buyer nodes 400-1 to 400-N for the specific digital content file.

The data management method may further include a processing step in which each of the file manager nodes 500-1 to 500-N provides a service of encrypting the transmission transaction result information data for each of the digital content files, on the basis of the transmission transaction result information data transmitted from each of the file buyer nodes 400-1 to 400-N for each of the specific digital content files, of recording and registering the encrypted transmission transaction result information data in a fourth distributed blockchain ledger, and sharing the fourth distributed blockchain ledger with the plurality of file manager nodes 500-1 to 500-N connected to the blockchain network.

In this case, the blockchain network is preferably configured such that the fourth distributed blockchain ledger in which the encrypted transmission transaction result information data for each of the digital content files is recorded and registered, is stored in a distributed manner in the form of a chain of blocks, in the blockchain storage units (not illustrated) of the respective file manager nodes 500-1 to 500-N.

In addition, the blockchain network is an on-blockchain network that is always online so that the transaction information data of each contract of each digital content file can be generated and recorded in the fourth distributed blockchain ledger at any time.

In this case, preferably, the transmission transaction result information data for the specific digital content file generated by the file buyer node 400-1, . . . , or 400-N includes a Merkle tree root hash value of the specific digital content file, which is calculated by using a Merkle hash tree algorithm, and final transmission transaction information data.

When one of the file buyer nodes 400-1 to 400-N receives a specific digital file from one of the file provider nodes 200-1 to 200-N which have contracted with each of the file seller nodes 300-1 to 300-N to provide digital content files including the specific digital content file, the file buyer node generates file reproduction result information data for the specific digital content file and transmits the generated file reproduction result information data to each of the file manager nodes 500-1 to 500-N.

The data management method may further include a processing step in which each of the file manager nodes 500-1 to 500-N provides a service of encrypting the file reproduction result information data transmitted from each of the file buyer nodes 400-1 to 400-N for the specific digital content file, of recording and registering the encrypted file reproduction result information data in a fifth distributed blockchain ledger, and sharing the fifth distributed blockchain ledger with the other file manager nodes 500-1 to 500-N connected to the blockchain network, and of settling profits of each node involved in distribution of the specific digital content file according to the file storage contract information data, the file sale contract information data, the file provision contract information data, and/or the file use contract information data.

In this case, the blockchain network is preferably configured such that the fifth distributed blockchain ledger in which the encrypted file reproduction result information data for each of the digital content file is recorded and registered is stored in a distributed manner as a chain of blocks in the blockchain storage units of the respective file manager nodes.

In addition, the blockchain network is an on-blockchain network that is always online so that the transaction information data of each contract of each digital content file can be generated and recorded in the fifth distributed blockchain ledger at any time.

Next, in Step 5500, each of the file manager nodes 500-1 to 500-N provides a service of: storing and managing the digital content files in a database form for each file producer node or for each digital content file, on the basis of the file registration request message including the file producer information data of each producer node and the file-related information of each digital content file, the file storage contract information data, the file sale contract information data, the file provision contract information data, and the file use contract information data that are transmitted in Steps 5100 through 5400; providing a service of processing payment for each of the specific digital content files by receiving file purchase and use information data for each of the specific digital content files from each of the file buyer nodes 400-1 to 400-N; and settling profits of each node involved in distribution of each of the specific digital content files, in accordance with the file storage contract information data, the file sale contract information data, the file provision contract information data, and the file use contract information data.

In this case, in Step 5500, on the basis of the file registration request message including the file producer information data and the file-related information of each of the digital content files, the file storage contract information data, and the file sale contract information data which are transmitted in Step 5100, each of the file manager nodes 500-1 to 500-1 provides a service of encrypting the file producer information data of each digital content file, the file-related information data of each digital content file, the file storage contract information data, and/or the file sale contract information data, of recording and registering the encrypted information data in a first distributed blockchain ledger, and sharing the first distributed blockchain ledger with a plurality of file manager nodes 500-1 to 500-N connected to a blockchain network.

The blockchain network is preferably configured such that the first distributed blockchain ledger in which the encrypted information data including the file producer information data, the file-related information data, the file storage contract information data, and/or the file sale contract information for each digital content file are recorded and registered is stored in a distributed manner in the form of a chain of blocks in the blockchain storage units (not illustrated) of the respective file manager nodes 500-1 to 500-N.

In addition, the blockchain network is an on-blockchain network that is always online so that the transaction information data of each transaction of each digital content file can be generated and recorded in the first distributed blockchain ledger at any time.

Additionally, after Step 5500, Step 5600 and Step 5700 may be performed. Step 600 refers to a processing step in which each of the file producer nodes 100-1 to 100-N transmits a file discard request message for discarding each of the digital content files to each of the file manager nodes 500-N to 500-N. Step 5700 refers to a processing step in which each of the file manager nodes 500-1 to 500-N changes the first distributed blockchain ledger such that the digital content files corresponding to the file discard request messages cannot be used, on the basis of the file discard request message transmitted in Step 5600 for each of the digital content files, and the changed first distributed blockchain ledger is shared by the file manager nodes 500-1 through 500-N connected to the blockchain network.

In addition, Step 5800 may be performed after Step 5700. Step 5800 refers to a processing step in which each of the file manager nodes 500-1 to 500-N forwards the file discard request message for the specific digital content file to each of the file provider nodes 200-1 to 200-N and/or each of the file seller nodes 300-1 to 300-N connected thereto through the communications network 10, on the basis of the file discard request message for each of the digital content files transmitted in Step 5500.

In addition, in Step 5500, each of the file manager nodes 500- to 500-N provides a service of encrypting the file provision contract information data for each of the digital content files, on the basis of the file provision contract information data transmitted in Step 5200, recording and registering the encrypted file provision contract information data in a second distributed blockchain ledger, and sharing the second distributed blockchain ledger with the file manager nodes 500-1 to 500-N connected to the blockchain network.

In addition, the blockchain network is preferably configured such that the second distributed blockchain ledger in which the encrypted file provision contract information data for each of the digital content files is recorded and registered is stored in a distributed manner in the form of a chain of data blocks, in the blockchain storage units (not illustrated) of the respective file manager nodes 500-1 to 500-N.

In addition, the blockchain network is an on-blockchain network that is always online so that the transaction information data of each transaction of each digital content file contract can be generated and recorded in the second distributed blockchain ledger at any time.

In addition, in Step 5500, each of the file manager nodes 500-1 to 500-N provides a service of encrypting the file use contract information data for each of the digital content files, on the basis of the file use contract information data transmitted in Step 5300 for each of the digital content files, recording and registering the encrypted file use contract information data in a third distributed blockchain ledger, and sharing the third distributed blockchain ledger with the file manager nodes 500-1 to 500-N connected to the blockchain network.

In this case, the blockchain network is preferably configured such that the third distributed blockchain ledger in which the encrypted file use information data for each of the digital content files is recorded and registered, is stored in a distributed manner in the form of a chain of data blocks in the blockchain storage units (not illustrated) of the respective file manager nodes 500-1 to 500-N.

In addition, the blockchain network is an on-blockchain network that is always online so that the transaction information data of each transaction of each digital content file can be generated and recorded in the third distributed blockchain ledger at any time.

In addition, in Step 5500, each of the file manager nodes 500- to 500-N provides a service of settling license fees for a specific digital content file and rewards for behavior of transmitting the specific digital content file on the basis of the file storage contract information data, the file sale contract information data, the file provision contract information data and/or the file use contract information data, for the specific digital content file. In this case, the license fees include royalties given to a relevant one of the file producer nodes 100-1 to 100-N, a provision service fee given to a relevant one of the file provider nodes 200-1 to 200-N, and a sales revenue given to a relevant one of the file seller nodes 300-1 to 300-N, for the specific digital content file. The rewards are given to actual file senders (for example, contribution peer nodes) of the specific digital content file as file transmission costs according to a degree of contribution of each file sender.

The data management method of distributing digital content files according to an embodiment of the present invention may be implemented as a computer-readable code recorded on a computer-readable recording medium. Examples of the computer-readable recording medium includes all kinds of recording devices on which data that can be read by a computing system can be recorded.

For example, a ROM, a RAM, a CD-ROM, a magnetic tape, a hard disk, a floppy disk, a removable storage device, a nonvolatile memory, or an optical data storage device may be used as the computer-readable recording medium.

In addition, the computer-readable code refers to a code that can be distributed to computing systems connected via a computer communication network. The computer-readable code can be read and executed in a distributed manner by the computing systems.

Although a data management system and method of distributing digital content files, according to exemplary embodiments of the present invention, have been described above, the present invention should not be construed to be limited to the exemplary embodiments, but may be modified in various forms without departing from the scope of the present invention defined by the appended claims and from the technological gist of the present invention described in the specification and illustrated in the accompanying drawings.

What is claimed is:

1. A data management system for distributing a digital contents file, the data management system comprising:
at least one file producer node configured to generate at least one digital content file and to transmit a file registration request message containing file producer information data of each producer node and file-related information data of each digital content file which are required for registration of each digital content file, along with file storage contract information data based on a file storage contract with a predetermined file producer node in order to store each of the digital content files and file sale contract information data based on a file sales contract with a predetermined seller node in order to sell each of the digital content files;
at least one file provider node configured to collect the digital content files generated by each of the file producer nodes, to store the digital content files in a database (DB) form in a storage unit by grouping the digital content files by file producer node or by digital content file, and to transmit file provision contract information based on a file provision contract with a predetermined file seller node in order to provide each of the file content files;
at least one seller node provided with a transmission channel for transmitting each of the digital content files stored in the storage units provided in the respective file provider nodes, and configured to provide a file sale service of selling the digital content files through the transmission channels and to transmit file use contract information data based on a file use contract;
at least one file buyer node configured to purchase a specific digital content file in accordance with the file use contract information, on the basis of the file sale service provided by each of the file seller nodes, to download the specific digital content file from the file provider node according to the file provision contract between the file seller node and the file provider node; and
at least one file manager node connected with each of the file producer nodes, each of the file provider nodes, each of the file seller nodes, and each of the file buyer nodes via a communication network, the at least one file manager node providing a file distribution service of receiving a file registration request message including file producer information data of each file producer and file-related information data of each digital content file transmitted from each of the file producer nodes, each of the file provider nodes, and each of the file seller nodes, along with file storage contract information data, file sale contract information data, file provision contract information data, and file use contract information data, of storing and managing the received file registration request messages and the received information data in a database form for each digital content file or each file producer node, of receiving file purchase and use information data for a specific digital content file from each of the file buyer nodes, of processing payment for the specific digital content file on the basis of the received file purchase and use information data, and of settling profits of each node involved in the service according to the file storage contract information data, the file sale contract information data, the file provision contract information data, and the file use contract information data.

2. The data management system according to claim 1, wherein each of the file manager nodes provides a service of receiving the file registration request message including the file producer information data of each producer node and the file-related information of each of the digital content files transmitted from each of the file producer nodes, along with the file storage contract information data and the file sale contract information data, encrypting the file producer information data, the file-related information data of each digital content file, the file storage contract information data, and the file sale contract information data, recording and registering the encrypted information data in a first distributed blockchain ledger, and enabling the first distributed blockchain ledger in which the encrypted information data is recorded to be shared by a plurality of file manager nodes connected to a blockchain network.

3. The data management system according to claim 2, wherein the blockchain network is configured such that the first distributed blockchain ledger is stored in a distributed manner as a chain of blocks in storage units of the respective file manager nodes, wherein in the first distributed block chain ledger, the encrypted information data including the file producer information data of each digital content file, the file-related information data of each digital content file, the file storage contract information data, and the file sale contract information is recorded and registered.

4. The data management system according to claim 2, wherein each of the file producer nodes transmits a file discard request message for each digital content file, to each of the file manager nodes, and each of the file manager nodes has a function of receiving the file discard request messages for the respective digital content files transmitted from the file producer nodes, changing the first distributed blockchain ledger such that the digital content files recorded and registered in the first distributed blockchain ledger become unusable, on the basis of the file discard request messages, and enabling the changed first distributed blockchain ledger to be shared by the file manager nodes connected to the blockchain network.

5. The data management system according to claim 4, wherein each of the file manager nodes receives the file discard request messages for the respective digital content files transmitted from the file producer nodes and forwards the file discard request messages to the file provider nodes and the file seller nodes connected through the communication network such that digital content files corresponding to the file discard request messages are discarded.

6. The data management system according to claim 2, wherein the blockchain network is configured to be always online so that transaction information data of each of the digital content files is generated and recorded in the first distributed blockchain ledger at any time.

7. The data management system according to claim 1, wherein each of the file manager nodes has a function of receiving the file provision contract information data for each of the digital content files transmitted from the file provider nodes, encrypting the file provision contract information data for each of the digital content files, on the basis of the received information data, recording and registering the encrypted file provision contract information data in a second distributed blockchain ledger, and enabling the second distributed blockchain ledger to be shared by a plurality of file manager nodes connected to a blockchain network.

8. The data management system according to claim 7, wherein the blockchain network is configured such that the second distributed blockchain ledger in which the encrypted file provision contract information data for each of the digital content files is recorded and registered is stored in a distributed manner as a chain of blocks in storage units of the respective file manager nodes.

9. The data management system according to claim 7, wherein the blockchain network is configured to be always online so that transaction information data of each of the digital content files is generated and recorded in the second distributed blockchain ledger at any time.

10. The data management system according to claim 1, wherein each of the file manager nodes provides a service of receiving the file use contract information data for each of the digital content files transmitted from the file provider nodes, encrypting the file use contract information data for each of the digital content files on the basis of the received file use contract information data, recording and registering the encrypted file use contract information data in a third distributed blockchain ledger, and enabling the third distributed blockchain ledger to be shared by a plurality of file manager nodes connected to a blockchain network.

11. The data management system according to claim 10, wherein the blockchain network is configured such that the third distributed blockchain ledger in which the encrypted file use contract information is recorded and registered is stored in a distributed manner as a chain of blocks in storage units of the respective file manager nodes.

12. The data management system according to claim 10, wherein the blockchain network is configured to be always online so that transaction information data of each of the digital content files is generated and recorded in the third distributed blockchain ledger at any time.

13. The data management system according to claim 1, wherein each of the digital content files generated by the file producer nodes comprises at least one data file selected from among a video data file, an image data file, an audio data file, and a document data file.

14. The data management system according to claim 1, wherein in order to download a specific digital content file from one of the file provider nodes that have contracted with at least one of the file seller nodes to provide digital content files including the specific digital content file, each of the file buyer node operates in conjunction with one of the file seller nodes or one of the file provider nodes, thereby receiving a complete copy of the specific digital content file in a manner of receiving pieces of the digital content file from a tracker peer node having file transmission information data required for transmission of the specific digital content file and from a plurality of contribution peer nodes in which the respective pieces of the specific digital content file are stored, in a peer-to-peer communication manner, according to a file transmission option selected by the file buyer node and then using the complete copy of the specific digital content file.

15. The data management system according to claim 14, wherein the tracker peer node has the file transmission information data including: hash information data of the specific digital content file; information data of an address list of seeders having a complete copy of the specific digital content file, and information data of an address list of leachers each of which has a copy of a piece of the digital content file.

16. The data management system according to claim 14, wherein the file transmission service option includes at least one of a network speed option for selecting highest ranked contribution peer nodes for a data transfer rate among the contribution peer nodes; a transmission cost option for selecting least expensive contribution peer nodes among the contribution peer nodes regardless of the data transfer rate; and a sender reliability option for selecting highest ranked contribution peer nodes for sender reliability among the contribution peer nodes.

17. The data management system according to claim 14, wherein after each of the file buyer nodes receives all the pieces of the specific digital content file from the contribution peer nodes, each of the file buyer nodes generates transmission transaction result information data for the specific digital content file and transmits the generated transmission transaction result information data to at least one of the file manager nodes connected thereto via the communication network.

18. The data management system according to claim 17, wherein each of the file manager nodes provides a service of setting profits of each node involved in the transaction of each of the digital content files, on the basis of the transmission transaction result information data received from the each of the file buyer nodes.

19. The data management system according to claim 17, wherein each of the file manager nodes provides a service of receiving the transmission transaction result information data for the specific digital content file, transmitted from each of the file buyer nodes, encrypting the transmission transaction result information data for each of the digital content files, on the basis of the received the transmission transaction result information data, recording and registering the encrypted transmission transaction result information data in a fourth distributed blockchain ledger, and enabling the fourth distributed blockchain ledger to be shared by a plurality of file manager nodes connected to a blockchain network.

20. The data management system according to claim 19, wherein the blockchain network is configured such that the fourth distributed blockchain ledger in which the encrypted transmission transaction result information data is recorded and registered is stored in a distributed manner as a chain of blocks in storage units of the respective file manager nodes.

21. The data management system according to claim 19, wherein the blockchain network is configured to be always online so that transaction information data of each of the digital content files is generated and recorded in the fourth distributed blockchain ledger at any time.

22. The data management system according to claim 17, wherein the transmission transaction result information data for the specific digital content file, generated by each of the file buyer nodes, includes a Merkle tree root hash value of the specific digital content file, which is calculated by using a Merkle hash tree algorithm, and final transmission transaction history information data.

23. The data management system according to claim 1, wherein each of the file manager nodes provides a service of settling license fees and rewards on the basis of the file storage contract information data, the file sale contract information data, the file provision contract information data, and the file use contract information data for the specific digital content file, wherein the license fees include royalties given to each of the file producer nodes, a provision service charge given to each of the file provider nodes, and sales earnings given to each of the file seller nodes, and the rewards include a reward for each of the nodes that have actually contributed to transmission of the specific digital content file, the reward being determined according to a degree of contribution of each of the nodes.

24. The data management system according to claim 1, wherein each of the file buyer nodes generates file reproduction result information data for the specific digital content file after receiving and using the specific digital content file from the at least one file provider node which has contracted with the at least one file provider node to provide digital content files.

25. The data management system according to claim 24, wherein each of the file manager nodes has a function of receiving the file reproduction result information data for the specific digital content file, transmitted from each of the file buyer nodes, of encrypting the file reproduction result information data for the specific digital content file, on the basis of the received file reproduction result information data, of recording and registering the encrypted file reproduction result information data in a fifth distributed blockchain ledger, and of enabling the fifth distributed blockchain ledger to be shared by a plurality of file manager nodes connected to a blockchain network.

26. The data management system according to claim 25, wherein the blockchain network is configured such that the fifth distributed blockchain ledger is stored in a distributed manner as a chain of blocks in storage units of the respective file manager nodes.

27. The data management system according to claim 25, wherein the blockchain network is configured to be always online so that transaction information data for each of the digital content files is generated and recorded in the fifth distributed blockchain ledger at any time.

28. The data management system according to claim 1, wherein each node of the file producer nodes, the file provider nodes, the file seller nodes, the file buyer node, and the file manager node comprises at least one of a module, a device, a terminal, and a server.

29. A data management method of distributing a digital contents file, the data management method being implemented by a system in which at least one file producer node, at least one file supplier node, at least one file seller node, at least one file buyer node, and at least one file manager node are connected to each other via a communication network, the data management method comprising:
(a) by each of the file producer nodes, generating at least one digital content file and transmitting a file registration request message containing file producer information data of a producer node that has generated the at least one content file and file-related information data of each of the generated digital content files, which are required for registration of each of the digital content files, along with file storage contract information data based on a file storage contract with a predetermined file provider node of the file provider nodes in order to store each of the digital content files and file sale contract information data based on a file sale contract with a predetermined seller node of the file seller nodes in order to sell each of the digital content files;
(b) by each of the file provider nodes, collecting the digital content files generated by each of the file producer nodes, storing the collected digital content files in a database (DB) format in a storage unit thereof by grouping the digital content files by file producer node or by digital content file, and transmitting file provision contract information based on a file provision contract with a predetermined file seller node of the file seller nodes in order to provide each of the file content files;
(c) by each of the file seller nodes, transmitting file use contract information data based on a file use contract with each of the file buyer nodes in order to sell each of the digital content files, in which each of the file seller nodes has a transmission channel for transmitting each of the digital content files stored in each of the file storage units provided in the respective file provider nodes and provides a file sale service for selling the digital content files using the transmission channel thereof;
(d) by each of the file buyer nodes, purchasing a specific digital content file in accordance with the file use contract information, on the basis of the file sale service provided by each of the file seller nodes, thereby receiving the specific digital content file from a file provider node which has contracted with each of the file seller nodes to provide digital content files including the specific digital content file; and
(e) by each of the file manager nodes, providing a service of (e1) storing and managing the digital content files in a database form by grouping the digital content files by file producer node or digital content file, on the basis of the file registration request message including the file producer information data and the file-related information of each of the digital content files, the file storage contract information data, the file sale contract information data, the file provision contract information data, and the file use contract information data, (e2) processing payment for the specific digital content file by receiving file purchase and use information data for the specific digital content file, received from the at least one file buyer node, and (e3) settling profits of each node involved in the transaction of the specific digital contract, in accordance with the file storage contract information data, the file sale contract information data, the file provision contract information data, and the file use contract information data.

30. The data management method according to claim 29, wherein in the (e) step, on the basis of the file registration request message including the file producer information data of each of the digital content files and the file-related information of each of the digital content files transmitted from each of the file producer nodes, the file storage contract information data, and the file sale contract information data, the service is provided such that the file producer information data of each digital content file, the file-related information data of each digital content file, the file storage contract information data, and the file sale contract information data are encrypted, recorded, and registered in a first distributed blockchain ledger, and the first distributed blockchain ledger in which the encrypted information data including the file producer information data, the file-related information data, the file storage contract information data, and the file sale contract information data is recorded and registered is shared by a plurality of file manager nodes connected to a blockchain network.

31. The data management method according to claim 30, wherein the blockchain network is configured such that the first distributed blockchain ledger in which the encrypted information data including the file producer information data, the file-related information data, the file storage contract information data, and the file sale contract information data is recorded and registered is stored in a distributed manner as a chain of blocks in storage units of the respective file manager nodes.

32. The data management method according to claim 30, further comprising:
(f) by each of the file producer nodes, transmitting a file discard request message for each of the digital content files, to each of the file manager nodes; and
(g) by each of the file manager nodes, providing a service of changing the first distributed blockchain ledger so that the specific digital content file record and registered in the first distributed blockchain ledger cannot be used, on the basis of the file discard request message transmitted in the (f) step, and enabling the changed first distributed blockchain ledger is shared by the file manager nodes connected to the blockchain network,
wherein the (f) step and the (g) step are performed after the (e) step.

33. The data management method according to claim 32, further comprising: by each of the file manager nodes, transmitting a file discard request message for each of the digital content files to each of the file provider nodes and to each of the file seller nodes through the communication network such that the corresponding digital content files are discarded on the basis of the file discard request message for each of the digital content files transmitted in the (f) step, wherein the transmitting of the file discharged request message is performed after the (g) step.

34. The data management method according to claim 30, wherein the blockchain network is configured to be always online so that transaction information data of each of the digital content files is generated and recorded in the first distributed blockchain ledger at any time.

35. The data management method according to claim 29, wherein in the (e) step, by each of the file manager nodes, providing a service of encrypting the file provision contract information data for each of the digital content files, on the basis of the file provision contract information data transmitted in the (b) step, recording and registering the encrypted file provision contract information data in a second distributed blockchain ledger, and enabling the second distributed blockchain ledger to be shared by the plurality of file manager nodes connected to the blockchain network.

36. The data management method according to claim 35, wherein the blockchain network is configured such that the second distributed blockchain ledger in which the encrypted file provision contract information data for each of the digital content files is recorded and registered is stored in a distributed manner as a chain of blocks in storage units of the respective file manager nodes.

37. The data management method according to claim 35, wherein the blockchain network is configured to be always online so that transaction information data of each of the digital content files is generated and recorded in the second distributed blockchain ledger at any time.

38. The data management method according to claim 29, in the (e) step, by each of the file manager nodes, providing a service of encrypting the file use contract information data for each of the digital content files, on the basis of the file use contract information data transmitted in the (c) step, recording and registering the encrypted file use contract information data in a third distributed blockchain ledger, and enabling the third distributed blockchain ledger to be shared by the plurality of file manager nodes connected to the blockchain network.

39. The data management method according to claim 38, wherein the blockchain network is configured such that the third distributed blockchain ledger in which the encrypted file use contract information data for each of the digital content files is recorded and registered is stored in a distributed manner as a chain of blocks in storage units of the respective file manager nodes.

40. The data management method according to claim 38, wherein the blockchain network is configured to be always online so that transaction information data of each of the digital content files is generated and recorded in the third distributed blockchain ledger at any time.

41. The data management method according to claim 29, wherein each of the digital content files generated by each of the file producer nodes in the (a) step is composed of at least one data file selected from among a video data file, an image data file, an audio data file, and a document data file.

42. The data management method according to claim 29, wherein when downloading a specific digital content file from a predetermined file provider node of the file provider nodes that have contracted with each of the file seller nodes to provide the specific digital content file in the (d) step,
each of the file buyer nodes operates in conjunction with each of the file seller nodes or each of the file provider nodes, thereby obtaining a complete copy of the specific digital content file in a manner of receiving copies of distributed pieces of the digital content file from a tracker peer node having file transmission information data required for transmission of the specific digital content file and from a plurality of contribution peer nodes in which the pieces of the specific digital content file are stored, in a peer-to-peer communication manner, according to a file transmission option selected by the file buyer node and then using the complete copy of the specific digital content file.

43. The data management method according to claim 42, wherein the tracker peer node has the file transmission information data including: hash information data of the specific digital content file; information data of an address list of seeders having a complete copy of the specific digital content file; and information data of an address list of leachers having a copy of a piece of the digital content file.

44. The data management method according to claim 42, wherein the file transmission service option comprises at least one of a network speed option for selecting highest ranked peer nodes for a data transfer rate among the contribution peer nodes, a transmission cost option for selecting least expensive peer nodes among the contribution peer nodes regardless of the data transfer rate, and a sender reliability option for selecting highest ranked peer nodes for reliability among the contribution peer nodes.

45. The data management method according to claim 42, wherein after each of the file buyer nodes receives the copies of all the pieces of the specific digital content file from the contribution peer nodes, each of the file buyer nodes generates transmission transaction result information data for the specific digital content file and transmits the generated transmission transaction result information data to at least one of the file manager nodes connected thereto via the communication network.

46. The data management method according to claim 45, wherein each of the file manager nodes provides a service of settling profits of each node for behavior of transmitting the specific digital content file, on the basis of the transmission transaction result information data received from each of the file buyer nodes.

47. The data management method according to claim 45, further comprising: by each of the file manager nodes, providing a service of encrypting the transmission transaction result information data for each of the digital content files, on the basis of the transmission transaction result information data for each of the specific digital content files, the data being transmitted from each of the file buyer nodes, recording and registering the encrypted transmission transaction result information data in a fourth distributed blockchain ledger, and enabling the fourth distributed blockchain ledger to be shared by a plurality of file manager nodes connected to a blockchain network.

48. The data management method according to claim 47, wherein the blockchain network is configured such that the fourth distributed blockchain ledger in which the encrypted transmission transaction result information data for each of the digital content files is recorded and registered is stored in a distributed manner as a chain of blocks in storage units of the respective file manager nodes.

49. The data management method according to claim 47, wherein the blockchain network is configured to be always online so that transaction information data of each of the digital content files is generated and recorded in the fourth distributed blockchain ledger at any time.

50. The data management method according to claim 45, wherein the transmission transaction result information data generated by each of the file buyer nodes for the specific digital content file comprises a Merkle tree root hash value of the specific digital content file, which is calculated by using a Merkle hash tree algorithm, and final transmission transaction history information data.

51. The data management method according to claim 29, wherein in the (e) step, each of the file manager nodes provides a service of settling license fees and rewards, on the basis of the file storage contract information data, the file sale contract information data, the file provision contract information data, and the file use contract information data for the specific digital content file, wherein the license fees include royalties to be given to each of the file producer nodes, a provision service charge to given to each of the file provider nodes, and sales earnings to be given to each of the file seller nodes, and the rewards include a reward for each of the nodes that has actually contributed to transmission of the specific digital content file, the reward being determined according to a degree of contribution of each of the nodes.

52. The data management method according to claim 29, further comprising: by each of the file buyer nodes, generating file reproduction result information data for the specific digital content file and transmitting the generated file reproduction result information data for the specific digital content file to each of the file manager nodes after each of the file buyer nodes receives and uses the specific digital content file transmitted from one of the file provider nodes which have contracted with the at least one file provider node to provide digital content files in the (d) step.

53. The data management method according to claim 52, further comprising: by each of the file manager nodes, providing a service of encrypting the file reproduction result information data for the specific digital content file, on the basis of the file reproduction result information data received from each of the file buyer nodes for the specific digital content file, of recording and registering the encrypted file reproduction result information data in a fifth distributed blockchain ledger, and enabling the fifth distributed blockchain ledger to be shared by a plurality of file manager nodes connected to a blockchain network.

54. The data management method according to claim 53, wherein the blockchain network is configured such that the fifth distributed blockchain ledger in which the encrypted file reproduction result information data is recorded and registered is stored in a distributed manner as a chain of blocks in storage units of the respective file manager nodes.

55. The data management method according to claim 53, wherein the blockchain network is configured to be always online so that transaction information data for each of the digital content files is generated and recorded in the fifth distributed blockchain ledger at any time.

56. The data management method according to claim 29, wherein each of the file producer nodes, the file provider nodes, the file seller nodes, the file buyer node, and the file manager node comprises at least one of a module, a device, a terminal, and a server.

57. A computer-readable recording medium in which a program to execute the data management method according to claim 29 is stored.
